(19) United States
(12) Patent Application Publication
(10) Pub. No.: US 2020/0068298 A1
(43) Pub. Date: Feb. 27, 2020

(54) A SYSTEM AND METHOD FOR AN IN-MOUTH COMMUNICATOR

(71) Applicant: GDM INT. LTD, Nicosia (CY)

(72) Inventors: Nir (Max) LEVY, Hod Hasharon (IL); Daniel KARIO, Sydney (AU)

(21) Appl. No.: 16/465,906

(22) PCT Filed: Dec. 1, 2017
(86) PCT No.: PCT/CY2017/000003

§ 371 Date: May 31, 2019

(30) Foreign Application Priority Data
Dec. 2, 2016 (GB) 1620475.2

(51) Int. Cl. H04R 1/46; H04R 19/04; H04R 3/00

(52) U.S. Cl. CPC H04R 1/46; H04R 19/04; H04R 2420/07; H04R 2460/13; H04R 2201/003; H04R 3/00

(57) ABSTRACT

An in-mouth headset for use to send and receive an audio signal, the headset comprising: a bone conductor for producing a vibration indicative of the audio signal; a membrane adapted to be in contact with the bone conductor, and being shaped to multiply touch jawbone or sit between the teeth of the user, in use, wherein the membrane transfers the vibrations produced by the bone conductor so that an audio signal can be heard by the user; and a processing circuit adapted to convert the audio signal for reception from a communications device.

The present invention relates to a system and method for an in-mouth headset, particularly, a miniaturized single unit communicator.

Many devices are known which provide a means of communicating with another person or user, these tend to include headphones and microphones which are situated external to the body. In many situations there is a need to communicate without others knowing. An example of one such situation is in covert circumstances, such as secret use of a communications device. A number of different devices have been proposed to facilitate this, but they do not tend to work well and often are too big and bulky to enable a user to use them covertly. Fictional devices used in “spy films” have suggested the use of in-mouth communications systems. Erstwhile, these have not been practical in reality.

Accordingly, a need exists for an improved communications device or headset which overcomes at least some of the problems associated with current day technology.

An object of the present invention is to provide an in-mouth headset for use in covert applications.

According to one aspect of the present invention there is provided an in-mouth headset for use to send and receive an audio signal; the headset comprising: a bone conductor for receiving a vibration indicative of the audio signal; a membrane adapted to be in contact with the bone conductor, adapted to be in contact with a facial bone or sitting between the teeth of the user, in use, wherein the membrane transfers the vibrations from the bone conductor so that an audio signal can be heard by the user; and a processing circuit adapted to convert the audio signal for transmission to or reception from a communications device.

According to a second aspect of the present invention there is provided a method of sending an audio signal to a communications device from an in-mouth headset, the method comprising: producing a vibration indicative of the audio signal in a bone conductor via a membrane adapted to be in contact with the bone conductor, wherein the membrane is shaped to be in contact with a facial bone or sit between the teeth of the user, in use, and wherein the membrane transfers the vibrations to the bone conductor so that an audio signal can be heard by the user; and communication with the communications device.

Advantageously, various embodiments are provided by features as defined in the dependent claims.

The present invention will now be described, by way of example, with reference to the accompanying drawings, in which:

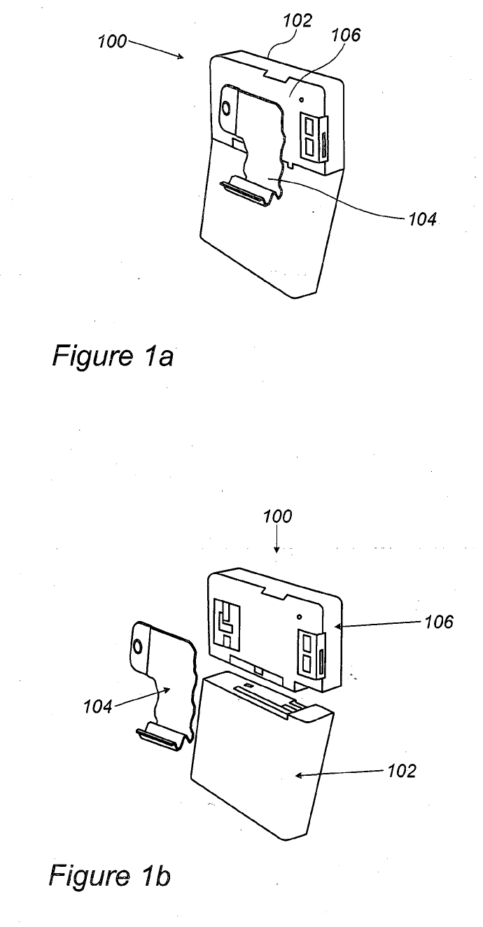

FIGS. 1a and 1b are simplified diagrams of a device, according to an aspect of the present invention;

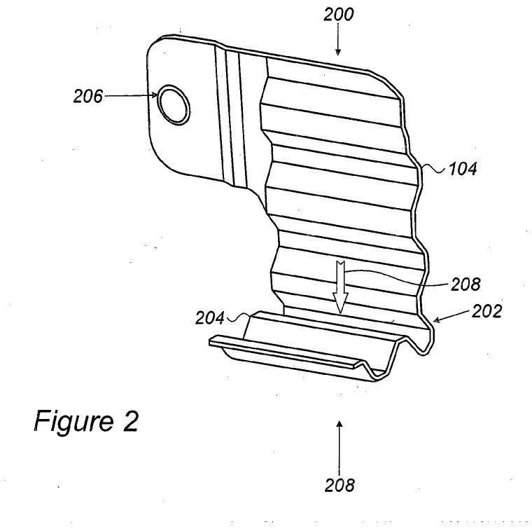

FIG. 2 is a diagram of a membrane for use in the FIG. 1 system, according to an aspect of the present invention;

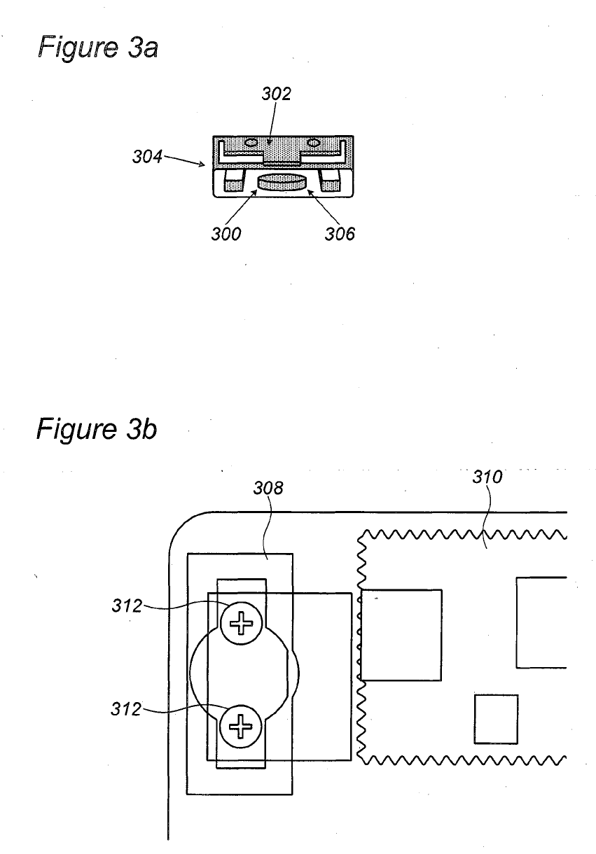

FIGS. 3a and 3b are diagrams of a bone conductor for use in the FIG. 1 system, according to an aspect of the present invention

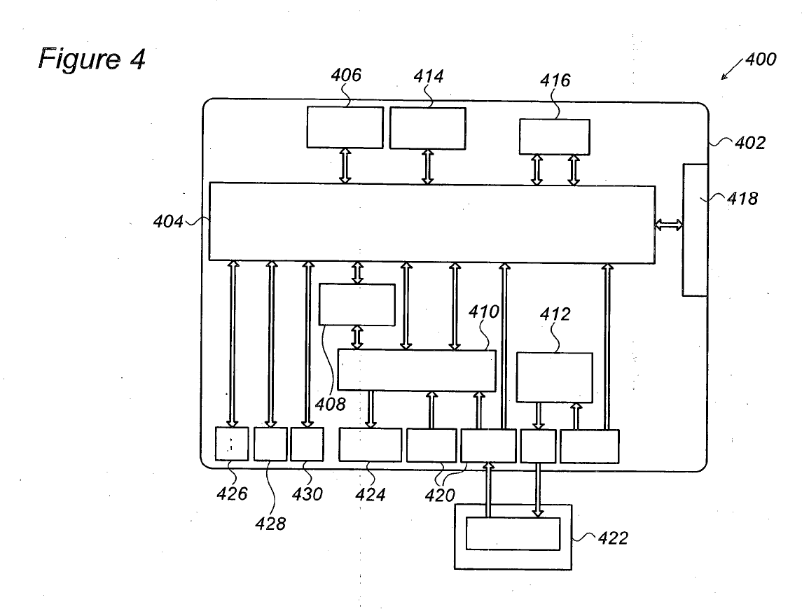

FIG. 4 is the block diagram of a signal processing system, according to an aspect of the present invention;

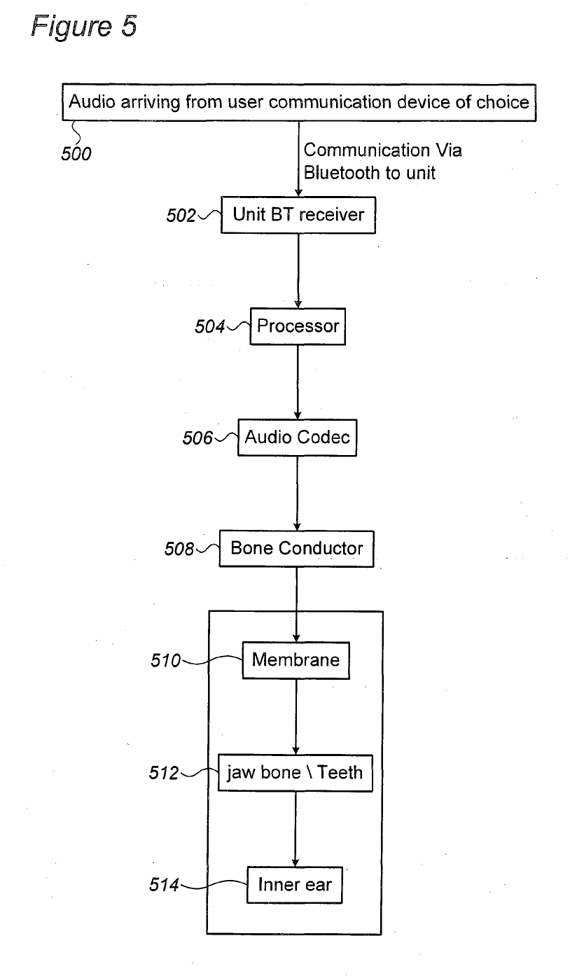

FIG. 5 is a flow diagram of audio in, according to an embodiment of the present invention;

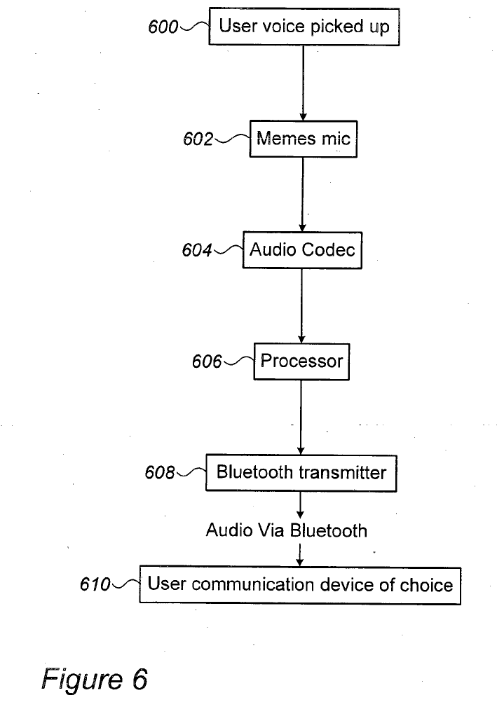

FIG. 6 is a flow diagram of audio out, according to an embodiment of the present invention; and

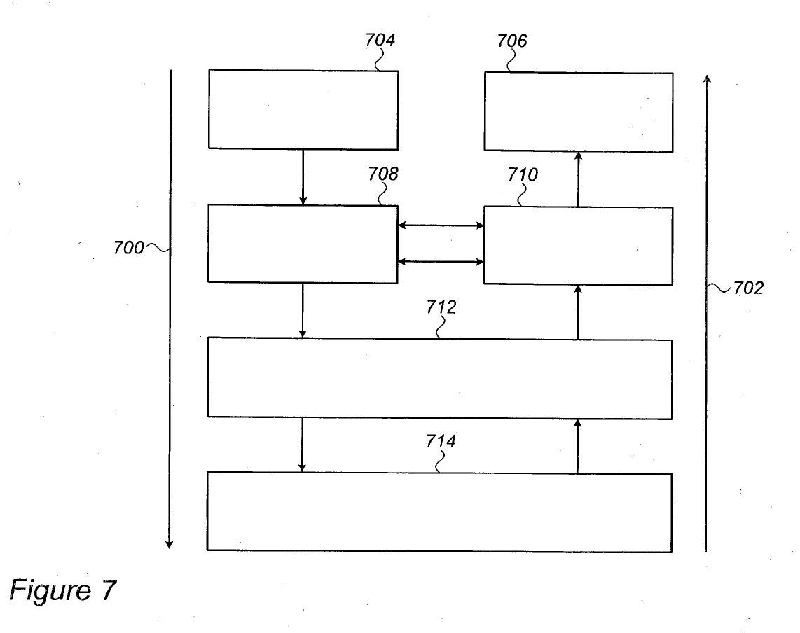

FIG. 7 is a flow diagram of the functional processing steps for audio in and audio out, according to an embodiment of the present invention.

In broad terms, the present invention relates to an intelligent audio headset and microphone which can be seated in the mouth of a user. This provides for a headset which can be used in any environment, without others knowing it is being used, if desired. The present invention offers a visually and audibly inconspicuous communications system that allows real-time audio communication (speaking and hearing) without being noticed. A user can talk and listen without being noticed, and does not need to conceal the fact he is talking. The invention provides optimal hands-free communication in crowded, noisy surroundings.

FIG. 1 shows a headset unit 100. The unit includes a housing 102 comprising a battery (not shown); a membrane 104 attached to the housing, a bone conductor (not shown in FIG. 1) and a printed circuit board (PCB) 106. The membrane 104 has a predetermined shape and is intended to vibrate in use. Similarly any sound received by the unit is passed from the PCB 106 to the bone conductor converted into vibrations which are conducted by the membrane 104 and can be detected by the ear of the user. The housing may be of any appropriate material, for example a silicon sleeve which seals and waterproofs the PCB 106. FIG. 1a show the unit in assembled form and FIG. 1b in an exploded view. The membrane is intended to be in touch with jawbone or clamped between the teeth and the housing lies against the side of the teeth between jaw and cheek.

FIG. 2 shows the membrane 104 in more detail. The membrane 104 includes an essentially corrugated metal structure 200. The membrane includes a lower section 202 which is intended to be clamped between respective rows of teeth of the user. The section is bitten on by the teeth in the direction of arrows 208

The membrane may be formed from an appropriately shaped stamped aluminum strip. The strip may be of the order of 0.5 mm thick. In addition, the shape and size may contribute to the amplification effect caused by the membrane and the transfer of sound to the user. The membrane 104 includes an attachment portion 206 which mechanically attaches the membrane to the bone conductor. The mechanical attachment may include a bolt, a weld or any other appropriate connector. The attachment allows the transfer of vibrational energy between the bone conductor and the membrane.

FIG. 3a shows the bone conductor in more detail. The bone conductor includes a copper coil 300 forming an electromagnet sandwiched between top and bottom plates 302 and 304 respectively. As current passes in the coil a magnetic field is created which causes the top plate 302 to vibrate. The ends of the copper coil 300 serve as connectors 306, which connect to the PCB and transmit low electrical pulses between the coil and the PCB. These pulses connect and disconnect the electromagnet casing vibration of the top plate 302. The audio output is passed thought the bone conductor coils and is converted into a vibration which shake the bone conductor outer body. As shown in FIG. 3b, the bone conductor sits in dedicated space 308 made within the PCB housing 310. The top plate is connected to the membrane with aid of miniatures screws 312 or any other appropriate fixing means.

The membrane transfers any vibrations created by the bone conductor to the jawbone or any teeth it touches. The sound is then heard in the ear as a result of the vibration. The bone conduction element transfers sounds (voice, music, etc.) to the user. The bone conductor touches multiple places in the user's mouth, and allows the user to have mechanical control of the volume. The volume control can be effected in a number of different ways. In one embodiment, the user can clamp or click his teeth on the membrane to increase or decrease the volume. By applying pressure to the cheek or by clamping down with the teeth there will be a greater area of contact and the vibrations will be amplified giving better hearing.

The PCB includes a plurality of processing elements which in combination comprise a processing circuit 400 which will now be described with reference to FIG. 4. The processing circuit 400 includes a main board 402; a processor 404; a first and second Bluetooth module 406, 408; an audio codec 410; and a power management module 412. Other circuit elements are also present as will be described in greater detail below.

The first Bluetooth module 406; a serial Flash module 414 for internal storage and a 7 pin CP connector 416 are connected to the processor 404 via connections of an appropriate type for the required signal protocol. The processor 404 also interfaces with a 40 pin header 418 via an appropriate connection to make a connection with the PCB.

The second Bluetooth module 408 forms an interface between the processor 404 and the audio codec 410 via appropriate connections. The processor is also directly connected to the audio codec. The audio codec receives microphone in signals 420 from a microphone module 422 and sends amplified audio out signals 424 to an appropriate device. The audio codec is used to process the audio signals in any manner required. This can include: compression and decompression of a digital audio data based on a given audio coding format by means of an algorithm. This enables the audio signal to be represented with a minimum number of bits while retaining a predetermined quality. This can effectively reduce the storage space and the bandwidth required for transmission or receipt of the generated audio file.

The power management module 412 may provide and control power supply to the various circuit elements and the microphone and speakers used by the unit.

In a number of preferred embodiments, the processor may also be in connection with one or more buttons 426; one or more USB ports 428; and more or more buzzers or alert modules 430.

In a typical use scenario, the user places the unit inside their mouth as described above. Hands-free communication is now possible without giving any visual or audible indication that communication is taking place. An audio signal is transmitted either over a Bluetooth connection to a Bluetooth enabled mobile phone or an appropriate Bluetooth adapter that forms part of the invention to a two-way radio or the like (not shown). The communications can in some embodiments be integrated into the unit and the Bluetooth element dispensed with. Audio in and audio out are dealt with is a different manner: audio in makes use of the bone conductor and membrane to enable the user to hear the signal and audio out is managed in a traditional manner.

The Bluetooth adapter can be connected to Wireless push-to-talk. (PTT) module (not shown). The unit or device is fully duplex - meaning the user can hear and speak in a normal manner with a third party. In one embodiment, the unit can be half duplex, so that the user can listen to music for example.

Referring now to FIG. 5, the incoming audio process will now be described. In step 500 audio arrives from a user communication device of choice. The communications device may be a phone, smartphone or any other appropriate device which is in communication by means of a predetermined protocol, such as, for example Bluetooth. A Bluetooth receiver in the unit receives the audio at step 502 and passes it to the processor in step 504 where it is processed. The audio packets arrive via a Bluetooth connection in a Bluetooth format and converted into a digital stream of audio. The processed signal is passed to the audio codec in step 506 where it is further processed. The audio codec acts as “the player” of the sound and converts the digital stream into the relevant signals needed by the bone conductor. A signal is then passed to the bone conductor at step 408 and converted into vibrations. The audio output is passed thought the bone conductor coils which convert the output into a vibration which vibrates the bone conductor outer body. The vibrational energy generated by the bone conductor is then passed to the membrane in step 510 where it is amplified and transferred to the bone and/or teeth in step 512. The vibrations are then detected and “heard” by the ear in step 514.

Referring now to FIG. 6, the outgoing audio process will now be described. In step 500 a user's voice is picked up. The sound is received at a MEMS (Micro Electrical-Mechanical System) microphone at step 602. The MEMS microphone is also referred to as a microphone chip or silicon microphone and generally comprises a pressure-sensitive diaphragm etched directly into a silicon wafer and is usually accompanied with integrated preamplifier. The received sound signal is passed to the audio codec in step 604 where it is processed. The audio codec converts the digital stream into the relevant signals needed by the unit. A signal is then passed it to the processor in step 606 where it is further processed by being converted into a digital stream of audio, before being passed to a Bluetooth transmitter in step 608. The generated audio signal is then passed via Bluetooth to a communications device in step 610.

Referring now to FIG. 7 the processing of the signals is further described. The diagram shows the audio out or talking path 700 and the audio in or listening path 702. The audio signal may be processed by one or more modules carrying out the following non limited steps.: receipt of audio by a microphone 704; generation of vibration at a bone conduct 706; filtering and noise removal 708; echo cancellation processes 710, such as a matrix; amplification of audio in or audio out 712; and transmission and receipt of the audio via Bluetooth 714.

The present invention thus provides a covert headset which can be used to communicate between a user and a third party via an appropriate communications device. The headset unit can be adapted for use by different users in different locations and is generally imperceptible to others.

It will be appreciated that the system and method has been described with reference to a number of different embodiments. These embodiments are not intended to be limitative and many variations are possible which will still fall within the scope of the present invention. The invention may be implemented in software, hardware or any combination thereof. Elements that are now illustrated as software can be changed to equivalent hardware elements and vice versa.

1. An in-mouth headset for use to send and receive an audio signal, the headset comprising:
a bone conductor for producing a vibration indicative of the audio signal;
a membrane adapted to be in contact with the bone conductor, via a facial bone or the teeth of the user, in use, wherein the membrane transfers the vibrations from the bone conductor so that an audio signal can be heard by the user; and a processing circuit adapted to process outgoing and incoming signals for transmission to or reception from a communications device.

2. The headset according to claim 1, wherein the membrane is a corrugated metal element.

3. The headset according to claim 2, wherein the membrane includes a section which is adapted to be in contact with the facial bone or to conform to the interdental space between the teeth of a user.

4. The headset according to claim 2, wherein the membrane is fixed to the bone conductor by a mechanical fixing.

5. The headset according to claim 1, further comprising a microphone for detecting the outgoing signal generated by the user.

6. The headset according to claim 5, wherein the microphone is a MEMS microphone.

7. The headset according to claim 1, wherein the processing unit communicates with the communications device via Bluetooth.

8. The headset according to claim 1, further comprising a housing.

9. The headset according to claim 8, wherein the housing is waterproof.

10. The headset according to claim 8, wherein the housing comprises a silicon sleeve.

11. A membrane for use with the headset of claim 1.

12. A silicon sleeve for use with the headset of claim 1.

13. A method of sending an audio signal from a communications device to an in-mouth headset, the method comprising:
transmitting the audio signal from the communications device; and producing a vibration indicative of the audio signal in a bone conductor via a membrane adapted to be in contact with the bone conductor, wherein the membrane is shaped to be in contact with a facial bone or the teeth of the user, in use, and wherein the membrane transfers the vibrations from the bone conductor so that an audio signal can be heard by the user.

14. The method according to claim 13, further comprising providing the membrane as a corrugated metal element.

15. The method according to claim 13, further comprising forming the membrane with a section which is adapted to be in contact with the facial bone or to conform to the interdental space between the teeth of a user.

16. The method according to claim 13, further comprising a detecting the outgoing signal generated by the user using a microphone.

17. The method according to claim 13, wherein the processing unit communicates with the communications device via Bluetooth.
